(19) United States
(12) Patent Application Publication
(10) Pub. No.: US 2024/0371552 A1
(43) Pub. Date: Nov. 7, 2024

(54) MAGNETIC COMPOSITIONS AND METHODS OF MAKING AND USING THE SAME

(71) Applicant: Horizon Technology, St. Marys, PA (US)

(72) Inventors: Francis Gary HANEJKO, Marlton, NJ (US); Phillip Preston MCDONALD, St. Marys, PA (US)

(21) Appl. No.: 18/292,413

(22) PCT Filed: Jul. 29, 2022
(86) PCT No.: PCT/US2022/038911

§ 371 Date: Jan. 26, 2024

Related U.S. Application Data
(60) Provisional application No. 63/227,002, filed on Jul. 29, 2021.

(51) Int. Cl. H01F 1/20; H02K 1/02

(52) U.S. Cl. CPC H01F 1/20; H02K 1/02

(57) ABSTRACT

A soft metal composition including a CuOFe₂O₃ magnetic oxide as well as methods of making and using the same are described. The soft magnetic composite may include, based on total weight of the composite, 95 to 99 weight percent iron, 0.1 to 3 weight percent electrically insulating material, 0.5 to 2 weight percent CuOFe₃O₃, and a balance of incidental impurities. The soft metal composition may be used to manufacture stators and rotors for electric motors.

### CROSS-REFERENCE TO RELATED APPLICATION

This application claims priority to U.S. Provisional Application Ser. No. 63/227,002, filed on Jul. 29, 2021, which is hereby incorporated by reference in its entirety.

### FIELD OF INVENTION

This invention generally relates to soft magnetic composites (SMCs) as well as methods of making and using the same.

### BACKGROUND

Soft magnetic composites (SMCs) may comprise ferromagnetic powder particles surrounded by an electrical insulating film. SMC components may be manufactured by conventional powdered metal (PM) compaction followed by a heat treatment at relatively low temperature. These composite materials may offer one or more advantages over traditional laminated steel cores in certain applications, including three-dimensional (3D) isotropic ferromagnetic behavior, low eddy current loss, low total core loss at medium and high frequencies, and reduced weight and production costs. These composite materials may be used in electromagnetic applications, automotive applications, and/or food and beverage applications. However, the electrical insulating film may reduce or prevent the transfer of magnetic flux from particle to particle, and thereby increase hysteresis losses. Accordingly, more efficient and/or cost-effective soft magnetic composites and methods of making and using the same may be desirable.

### DESCRIPTION OF THE DRAWINGS

The present invention described herein may be better understood by reference to the accompanying drawing sheets, in which:

FIG. 1 includes a metallographic SEM image of oxide coating formed during a process of making a SMC according to the present invention comprise a heat treatment.

FIGS. 2A and 2B include quantitative X-ray analysis of the oxide coating formed during a process of making a SMC according to the present invention comprise a heat treatment.

FIG. 3 includes an iron oxygen phase equilibria diagram of a SMC according to the present invention.

### DETAILED DESCRIPTION

This disclosure generally describes soft magnetic composites as well as methods of making and using the same. It is understood, however, that this disclosure also embraces numerous alternative features, aspects, and advantages that may be accomplished by combining any of the various features, aspects, and/or advantages described herein in any combination or sub-combination that one of ordinary skill in the art may find useful. Such combinations or sub-combinations are intended to be included within the scope of this disclosure. As such, the claims may be amended to recite any features, aspects, and advantages expressly or inherently described in, or otherwise expressly or inherently supported by, this disclosure. Further, any features, aspects, and advantages that may be present in the prior art may be affirmatively disclaimed. Accordingly, this disclosure may comprise, consist of, consist essentially or be characterized by one or more of the features, aspects, and advantages described herein. As used herein, the term “and/or” includes any and all combinations of one or more of the associated listed items.

All numerical quantities stated herein are approximate, unless stated otherwise. Accordingly, the term “about” may be inferred when not expressly stated. The numerical quantities disclosed herein are to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values are reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges are continuous and include every value between the minimum and maximum values. Any maximum numerical limitation recited herein is intended to include all lower numerical limitations. Any minimum numerical limitation recited herein is intended to include all higher numerical limitations.

In the following description, certain details are set forth in order to provide a better understanding of various features, aspects, and advantages the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the invention.

The terminology used herein is for the purpose of describing particular examples only and is not intended to be limiting. As used herein, the singular forms “a”, “an”, and “the” may be intended to include the plural forms as well, unless the context clearly indicates otherwise. The terms “comprises”, “comprising”, “including”, “having”, and “characterized by”, are inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms are to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

As generally used herein, the terms “left,” “right,” “front,” “rear,” “top,” “bottom,” “upper,” “lower,” “inside,” “outside,” “inboard,” “outboard,” “horizontal,” and/or “vertical” may be referenced from the user's point of view. Unless stated otherwise, “front” refers to that end of the device nearest to a user; “rear” refers to that end of the side that is opposite to or distal from the front; “left” refers to side to the left of or facing left from a user; and “right” refers to the side to the right of or facing right from that same user. “Horizontal” refers to a plane extending from left to right and aligned with the horizon, and “vertical” refers to a plane that is angled at 90 degrees to the horizontal.

As generally used herein, the phrase “free” refers to having 20 wt. % or less, “substantially free” refers to having 10 wt. % or less, “essentially free” means less than 5 wt. % and “completely free” means less than 1 wt. %.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

Soft magnetic composites (SMCs) may comprise iron powder particles coated with an electrically insulating layer to reduce/prevent electrical conductivity among the iron powder particles. This electrically insulating layer may be cured at a temperature up to 1200° F. and maintain its resistivity thereafter. Conventional electrically insulating layers may begin to degrade and may cause interparticle sintering at temperatures above 1200° F. (650° C.). This interparticle sintering may cause the resistivity of the electrically insulating layer to decrease and the core loss (heat build-up) to increase to undesirable levels. Thus, the benefits of SMC components may be reduced/eliminated at curing temperatures above 1200° F. On the other hand, limiting the maximum curing temperature to 1200° F. (650° C.) may not be sufficient to eliminate the cold working imparted to the particles during compaction. This cold working may restrict the movement of the magnetic domains and thereby decrease in permeability and increase the coercive force of the particles.

The present invention is directed to a method of making SMCs at curing temperatures of at least 1200° F. (e.g., greater than 1200° F., 1200-1500° F., 1200-1300° F., 1300-1400° F., 1400-1500° F. and greater than 1500° F.) while maintaining the resistivity of the electrically insulating layer. High purity water and atomized iron powder may be premixed with an electrically insulating material and an organic lubricant. For example, hexagonal boron nitride, cubic boron nitride, Fe₂O₃, magnetic ferrites or other inorganic compounds capable of withstanding a 1200-1500° F. thermal treatment without significant degrading may be used. Premixing may provide generally uniform dispersion of the both the electrically insulating material and the organic lubricant. The electrically insulating material may partially coat the iron powder particles (about 60% coating of the particles by a surface area calculation) to improve separation of the iron powder particles during the compaction step. The amount of electrically insulating material may be, by weight of the iron powder, at least 0.1%, up to 1%, 0.1-1%, 0.1-0.5%, 0.1-0.75%, 0.5-0.75%, 0.5 to less than 1%. The electrically insulating material comprises at least one of phosphorous acid, phosphorous oxide, silicon oxide and silica oxide. The organic lubricant may facilitate ejection of the SMC from the die after the powder is compacted in closed dies. The organic lubricant may comprise at least one of ethylene bis-stearamide, zinc stearate, or lithium stearate, for example. The balance of the composite may comprise incidental impurities, such as copper, aluminum, silicon, tungsten, and cobalt and other materials derived from the starting materials and/or through processing.

After compaction and ejection, the compacted SMC component may be heated in a furnace to remove the organic lubricant (often called de-lubrication). This step may create a network of inter-connected porosity within the compacted SMC component. The de-lubrication temperature may be from 700-800° F. (700-750° F., 725-775° F., 750° F., 775-800° F.) in an air (e.g., oxygen and nitrogen) atmosphere.

After the compacted SMC component is de-lubricated, it may be impregnated with an aqueous solution or any other suitable solvent capable of dissolving copper sulfate penta-hydrate meta and/or magnesium sulfate penta-hydrate solution by placing the compacted SMC component under vacuum and contacting the compacted SMC component with the solution (e.g., immersion). While under vacuum, the aqueous solution may infiltrate the compacted SMC component and surround the iron powder particles. The infiltration temperature may be from room temperature up to 180° F. (32-180° F., 90-120° F., 120-150° F., 150-180° F.). The copper or magnesium sulfate penta-hydrate may react with the iron to form an iron-oxide soft ferrite material. The amount of metallic sulfate may vary depending on the surface area of the iron particle powder. For example, the amount of metallic sulfate infiltration may be 1-5% (1-2.5%, 2.5-5%, 4-5%) of the weight of the initial SMC component.

After infiltration, the compacted SMC component may be dried to remove any remaining water and leave the sulfates. The dry, compacted SMC component may be then re-heated to 1000° F. (800-1200° F., 800-1000° F., 900-1000° F.) in a steam atmosphere to generate iron oxides (Fe₃O₄) on the surface of the iron powder particles. The presence of the oxides may cause the soft magnetic ferrite to form during subsequent steps.

After drying, the compacted SMC component may be reheated to 1400° F. (1000-1400° F., 1200-1600° F., 1200-1400° F.) in either a nitrogen atmosphere or partial oxygen atmosphere to react the copper or magnesium sulfate and form magnetic copper ferrite oxides (CuOFe₂O₃) or magnetic magnesium ferrite oxides (MgOFe₂O₃). The heating step may maintain the compacted SMC component for 5-60 minutes (5-30 minutes, 30-60 minutes, 15-45 minutes) at the reheating temperature.

Without wishing to be bound to any particular theory, the SMCs made according to the present invention may be characterized by an oxide network surrounding the iron particles and being free, substantially free, essentially free, and/or completely free of inter-particle sintering of the iron particles. Without wishing to be bound to any particular theory, it is believed that the higher temperature curing of the SMC material may generate a SMC component having a lower hysteresis loss portion of the total losses.

The present invention is directed to a method of making SMCs at curing temperatures above 1200° F. using and electrically insulating material (e.g., hexagonal boron nitride) and an organic lubricant and copper sulfate penta-hydrate meta or magnesium sulfate penta-hydrate as described herein.

When the SMC component is compacted during the compaction step, the SMC component may be subjected to higher than desirable strain hardening of the iron particles. This strain hardening decreases the magnetic permeability of the iron and increase the coercive force, which may cause higher hysteresis losses of the device. The strain hardening may be analogous to taking a fully sintered PM part and then sizing the component. Referring to Table 1, sizing may introduce higher than desirable strain hardening and a loss in magnetic performance. In contrast, making a SMC component according to the present invention by annealing at 1300-1500° F. (1300-1400° F., 1400-1500° F., 1350-1450° F.) after sizing may restore the magnetic performance to the as-sintered (fully annealed) condition.

Referring to Table 1, conventional SMCs may be made using a heat treatment or ‘curing’ step that is limited to a maximum temperature of 1200° F. (800-1200° F., 1000-1200° F., 800-1100° F.), which is below the ideal annealing temperature for cold worked iron powder components. Utilizing a higher curing temperature may restore the DC magnetic performance, but may degrade the electrically insulating layer existing between the powder particles. This degradation of the insulating layer may result in particle to particle sintering and a corresponding increase in the eddy current losses of the component. The net result may be a decrease in the overall performance of the AC component.

TABLE 1
Effects of Cold Working and Subsequent Annealing on the Magnetic
Performance of a Sintered PM material (FY-4500 at 6.8 g/cm³)

| | | Coercive | Maximum Induction |
|---|---|---|---|
| Condition | Permeability | force, Oe | at 15 Oe, kilo-Gauss |
| As-sintered | 2300 | 2.0 | 11 |
| As-sintered and sized | 1200 | 2.7 | 10.0 |
| As-sintered, sized and | 2300 | 2.2 | 11.0 |
| annealed (1500° F.) | | | |

The present invention is directed to an electrically insulating layer that withstands a curing temperature in the range of 1300-1500° F. (1300-1400° F., 1400-1500° F., 1350-1450° F.) without significant degradation and/or magnetic susceptibility. Materials of this type may comprise iron-oxides ferrites. These materials may have high electrical resistivity with magnetic permeability and magnetic saturation. These magnetic ferrites may have the general chemical composition as follows: MOFe₂O₃; where, M comprises a metallic element, such as manganese, zinc, copper or nickel. Mixtures of electrically coated iron powder with a fine dispersion of ferrite particles may show minor improvements in the magnetic performance but their usefulness may be limited because the electrically insulating layer applied to the iron powder may be unable to withstand the high ‘curing’ temperature necessary to fully restore the magnetic properties of the cold worked iron powder particles.

Iron-oxides ferrite materials may have high electrical resistivity and magnetic permeability. These materials may comprise complex oxides including iron, nickel, manganese, zinc and/or copper, for example. When the individual iron powder particles are coated with a uniform layer of oxide material and then annealed at a higher than normal temperature to convert the oxide layer to a ferrite layer, such a SMC material may have lower hysteresis losses because the iron powder is annealed to reduce the strain hardening of compaction and lower eddy current losses because the insulating coating is not degraded.

The present invention is directed to a method of making SMCs utilizing CuOFe₂O₃ whereby the iron powder may be initially coated with copper, mixed with a lubricant to facilitate compaction, de-lubricated, and thermally treated at a temperature (e.g., from 1300-1400° F., 1400-1500° F., 1350-1450° F.) sufficient to react the iron and copper to form CuOFe₂O₃. It also may be created by initially coating the iron particles with an iron oxide layer by using heat, water, and an oxygen environment. The water may optionally be mixed with an additive to increase the amount of oxidation, such as salt or iron nitrate, for example. The powder may then be coated with a copper solution to generate the copper oxide. Each of these oxides may also be coated over the iron particles at the same time. For example, this may be achieved by mixing both copper nitrate and iron nitrate together in water or a solvent to form a solution and then blending the iron powder while adding this solution to the powder. Next, the powder may be mixed with a lubricant to facilitate compaction and de-lubricated. Next, the component may be steam treated at a temperature of 800-1200° F., such as 1000° F., 800-1000° F., 1000-1200° F., to increase the amount of iron oxide available on the component. Next, this component may be thermally treated at a temperature (e.g., from 1300-1400° F., 1400-1500° F., 1350-1450° F.) sufficient to react the iron and copper to form CuOFe₂O₃

The method may generally comprise coating iron powder, with one or more oxide layers, premixing the iron powder with at least one lubricant to facilitate compaction and ejection from the die, de-lubricating the compacted iron powder and thermally treating the de-lubricated compact to form the SMC comprising copper iron oxide. The iron powder may comprise high purity iron powder having a particle size up to 500 micrometers, up to 300 micrometers, up to 175 micrometers, up to 90 micrometers, or up to 45 micrometers, such as, 45-500 micrometers, 90-300 micrometers, 175-300 micrometers, 1-45 micrometers.

The method may generally comprise coating of the iron powder with copper via an aqueous or suitable solvent solution. The copper may comprise copper nitrate and/or copper sulfate pentahydrate or other copper compounds having a high solubility in water and/or corresponding organic solvent. The copper sulfate and/or copper nitrate powders may be dissolved in water to generate the aqueous solution. This aqueous solution may contact the iron powder while the iron powder is being agitated. The mixture may be stirred to uniformly coat the iron powder with the aqueous copper solution. The amount of copper deposited on the iron powder may comprise 1-5% of the total weight of the iron powder, such as 1-2.5%, 2.5-5%, 2-4%, and 3.5-4.5%, for example. This amount may vary depending on the surface area of the iron powder. In general, larger particle size distributions may use less copper and smaller particle size distributions may use more. The thickness of the copper iron oxide ferrite may comprise 0.0001 to 0.001 inches (1-30 micrometers, 2.54-25.4 micrometers, 1-5 micrometers, 2-10 micrometers, 5-15 micrometers, 15-30 micrometers, 18-24 micrometers, 24-28 micrometers). The uniformity of the mixing and subsequent coating may impact the characteristics of the final SMC component. High intensity mixing devices, such as plow blades mixers, may be used to stir the mixture.

Once the iron powder is coated, the powder may be dried. Any suitable drying oven that removes all or substantially all traces of the water or solvent used in the coating step may be used. After the powder is dried, it may be mixed with suitable powder metallurgy compaction lubricants to facilitate ejection of the compacted article from the die. The lubricants may comprise ethylene bis stearamide and/or zinc stearate. During the mixing step, it may be desirable to add an inorganic lubricant, such as hexagonal boron nitride. The hexagonal boron nitride may partially coat each of the individual iron particles, e.g., up to 60%, 30-60%, 30-45%, 45-60% coating of the particles by a surface area. The HBN may partially coat the iron powder and facilitate keeping the particle separated during the compaction step. HBN may be characterized by an inherent lubricity and high temperature stability greater than 2000° F., greater than 2200° F., greater than 2400° F., and/or greater than 2200° F. up to 2400° F., for example. The HBN may be used to facilitate ejection of the component from the die after the powder is compacted in closed dies. The amount of HBN used may be 0.1-0.75% by weight of the iron powder, such as 0.1-0.3%, 0.2-0.5%, 0.25-0.75%, 0.3-0.6%, 0.4-0.6%, 0.5-0.75%, for example. In addition, other stable inorganic compounds may be used, such as cubic boron nitride, Fe₂O₃, magnetic ferrites, silicon dioxide powder and any other inorganic compounds capable of withstanding the 1300-1500° F. (e.g., 1300-1400° F., 1400-1500° F., 1350-1450° F.) thermal treatment without significant degrading.

After the premixing stage, the coated and premixed iron powder may be transferred to the compaction press to compact the powder to a desired shape. After compaction and ejection of the component, the as compacted SMC component may be heated in a furnace to remove the organic lubricant (often called de-lubrication). This step may create a network of inter-connected porosity within the compacted SMC component. The de-lubrication temperature may be from 700-800° F. ((700-750° F., 725-775° F., 750° F., 775-800° F.) in an air atmosphere, such as a nitrogen and oxygen atmosphere having oxygen content 3-30%, such as 3-9%, 4-16%, 6-18%, 15-30%, 18-24%, 14-28%, 25-30%, for example.

After the compacted SMC component is de-lubricated, it may be heat treated and/or impregnated with a second aqueous copper solution (e.g., copper sulfate penta-hydrate and/or copper nitrate and iron nitrate) to provide additional copper and iron for subsequent reactions. The impregnation step may be accomplished by contacting the component and solution. For example, placing the component in a suitable vessel under vacuum to remove any entrapped air within the component. Once the vacuum is established, the component may be immersed in the solution or the solution may be dispensed into the vessel to surround and/or cover the component. The vacuum may facilitate the infiltration of the de-lubricated component by surrounding the individual powder particles of the component with the solution. The infiltration temperature may be from room temperature up to 180° F. (e.g., 68-180° F., 75-150° F., 120-180° F.).

After the infiltration step, it may be desirable to dry the components to remove any remaining water. The sulfates and/or nitrides may remain as a coating on the surface of the component. When reheated to 1000° F. (e.g., 800-1200° F., 800-1000° F., 900-1000° F.) in a steam atmosphere, the sulfates and/or nitrides may create CuFe₃O₄ oxides on the surface of the iron powder. This oxide may form the soft magnetic ferrite of the final SMC component.

After the steam treating step, the component may be reheated to 1300-1500° F. (e.g., 1300-1400° F., 1400-1500° F., 1350-1450° F.) in a nitrogen atmosphere and/or a partial oxygen atmosphere (oxygen contents ranging from 20-30%, such as 20-25%, 24-28%, 25-30%, for example) for 20-60 minutes (e.g., 20-30 minutes, 30-45 minutes, 45-60 minutes). This reheating step may cause the copper coating to react with the iron substrate to form CuOFe₂O₃.

The copper ferrite coated material may be useful for powder manufacturing comprising atomizing iron powder, coating the iron powder with phosphorous acid, and adding a lubricant to aid in part ejection.

The copper ferrite coated material may be useful for parts manufacturing comprising compacting components into a final shape and curing the components from 1000-1250° F. to remove the binder. Conventional electrical coatings curing at temperatures greater than 1250° F. may degrade.

The powder manufacturing method according to the present invention may comprise atomizing iron powder, optionally, coating the iron powder with phosphorous acid, coating the iron powder with iron copper nitrate, optionally, drying/oxidizing the coated iron powder from 350-450° F., and optionally, adding a lubricant to aids in part ejection.

The parts manufacturing method for a component according to the present invention may comprise compacting the component into a final shape, optionally, removing the lubricant at a low temperature, optionally, steam treating the component, curing the component 1300° F. and/or annealing the components above 1300° F. in an atmosphere comprising, based on volume, 0-50% oxygen and a balance nitrogen, such as 100% nitrogen, 25-30% oxygen and 70-75% nitrogen. Without wishing to be bound to any particular theory, the treatment above 1300° F. may anneal the component to reduce the coercive force of the material and/or reduce the core losses of the material and/or generate copper ferrite (CuFe₂O₃) from the copper oxide and iron oxide available from the copper nitrate and iron nitrate coating. The copper ferrite coating may be magnetically permeable to increase the total magnetic permeability of the material as well as electrically resistant to allows for low eddy currents in the material system when used for an electric motor stator or similar electromagnetic device.

The SMC according to the present invention may comprise a component for any device that transmits alternating current into mechanical energy and/or mechanical energy into alternating current electrical energy, such as electric motors, solenoids, and generators (e.g., wind turbines), electric motor (e.g., rotors and stators), for example. The SMC according to the present invention may comprise a component of a motor used in aerial drones, electric aircraft, electric cars, HVAC, land drones, outdoor lawn equipment, electric scooters and bikes, power tools, off-road Recreational vehicles, farm equipment and vehicles, mining equipment and vehicles, and household appliances. The SMC according to the present invention may comprise high temperature sensors, internal combustion ignition coils, magnetic bearings, step up voltage transformers, step down voltage transformers, and voltage stable power supplies (for devices, such as computers and other electronic devices).

### EXAMPLE

The SMC as well as methods of making and using the same described herein may be better understood when read in conjunction with the following representative examples. The following examples are included for purposes of illustration and not limitation.

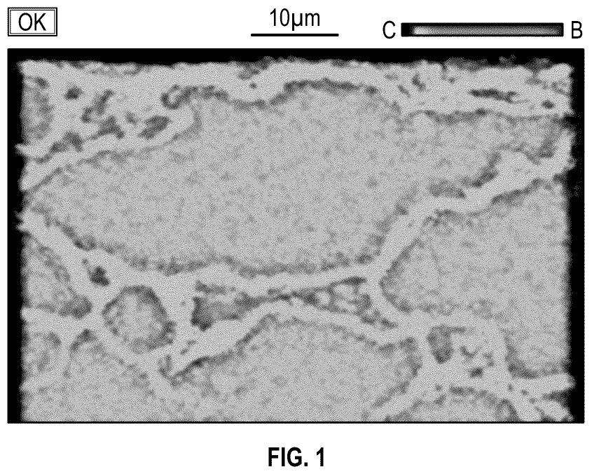

FIG. 1 describes metallographic SEM image of an oxide network formed during the heat treatment according to the present invention of the SMC material. The white areas show the iron powder substrate and the light gray areas show the oxides formed after a 1400° F. thermal treatment according to the present invention.

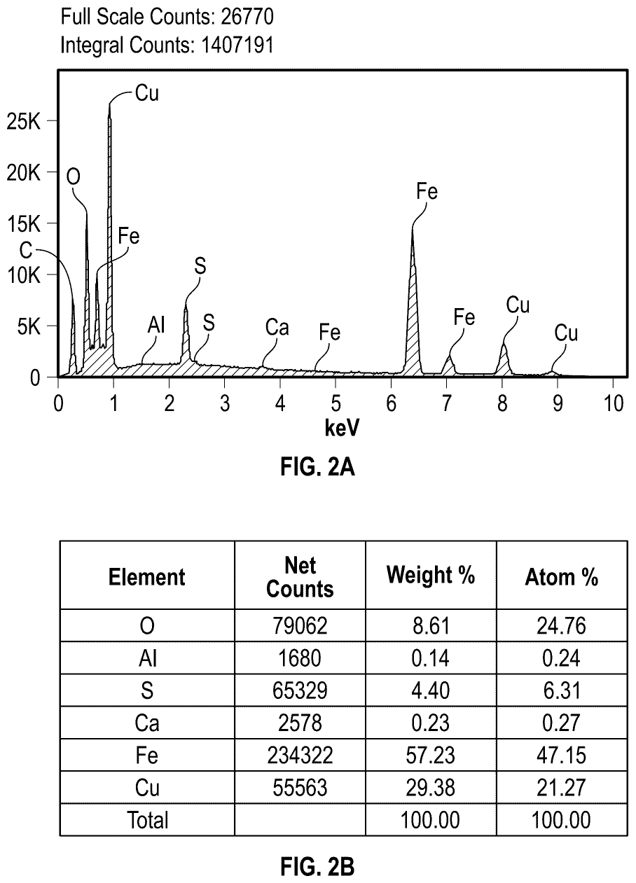

FIG. 2A describes quantitative X-ray analysis of the oxide formed according to the present invention.

FIG. 2B describes quantitative X-ray analysis of the oxide formed according to the present invention.

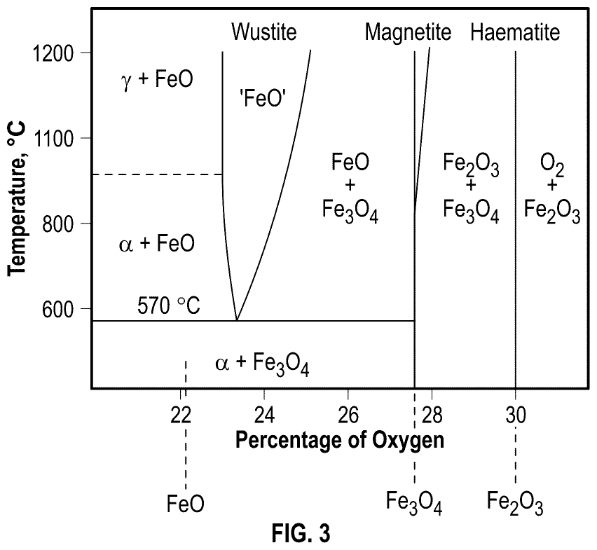

FIG. 3 describes the iron oxygen phase equilibria diagram.

### Example 1

High purity iron powder having a particle size from 500 micrometers to less than 45 micrometers is mixed with 0.50-0.75 weight percent, based on the total weight of the iron powder, hexagonal boron nitride powder having a size range of 5-10 micrometers in diameter, and 0.2 to 0.75% weight percent, based on the total weight of the iron powder, ethylene bis-stearamide and dispensed into a closed die. The mixture is compacted at pressures up to 830 MPa at room temperatures and die temperatures up to 150° C. for compaction times of 1 to 2 seconds and ejected from the closed die to form a compacted SMC component. The compacted SMC component is heated to a temperature of 700-800° F. in an air atmosphere (i.e.., 20% oxygen and 80% nitrogen) for 30 to 90 minutes to remove the organic lubricant and create a network of inter-connected porosity within the compacted SMC component. The compacted SMC component is impregnated with an aqueous solution of copper sulfate penta-hydrate under vacuum at a temperature of up to 190° F. for 30 minutes. The amount of copper sulfate infiltration is 1 to 3 weight percent, based on the total weight of the impregnated, compacted SMC component is heated to 1000° F. via steam treatment to generate Fe₃O₄ on the surface of the iron powder. The impregnated, compacted SMC component is reheated to 1400° F. for 30 to 60 minutes in a pure nitrogen atmosphere to cause the copper coating to react with the iron substrate to form a soft magnetic component comprising an oxide.

FIG. 1 shows scanning electron metallographic analysis near the surface of the SMC according to the present invention. FIG. 1 shows the iron powder particles (black regions) and the oxide (gray regions) surrounding the iron particles. The metallographic analysis shows the method according to the present invention may generate a sustainable oxide layer after thermal treatment at 1400° F. Additional analysis performed on the sample showed that the chemical makeup of the oxide layer contained both copper and iron oxides. FIG. 2A shows the analysis of the oxide layer via quantitative x-ray analysis.

Copper iron oxide ferrite (CuOFe₂O₃) comprises about 46.6 weight percent iron, 26.5 weight percent copper and 26.7 weight percent oxygen. FIG. 2B shows that the oxide formed according to the present invention comprises 57.2 weight percent iron, 29.4 weight percent copper and 8.6 weight percent oxygen. This suggests that the oxide formed is not CuOFe₂O₃ but CuFeO, which is not magnetic. However, the final thermal treatment at 1400° F. in nitrogen results in a loss of oxygen of the original Fe₃O⁴ oxide. Without wishing to be bound by any particular theory, it is believed that CuOFe₂O₃ is formed when the SMC component is reheated in a nitrogen/oxygen atmosphere containing 27% to 30% oxygen. The lack of a sufficient amount of oxygen in the furnace atmosphere during the final thermal treatment prevented the formation of CuOFe₂O₃. Despite having insufficient oxygen available during the final thermal treatment, the actual oxide formed may be shown by the phase stability of the oxides in this atmosphere.

### Example 2

High purity iron powder having a particle size from 500 micrometers to less than 45 micrometers is mixed with 0.50-7.75 weight percent, based on the total weight of the iron powder, hexagonal boron nitride, and 0.5 to 0.75% weight percent, based on the total weight of the iron powder, ethylene bis-stearamide and dispensed into a closed die. The mixture is compacted in suitable magnetic toroids, an annular ring having an inner diameter to outer diameter ratio of about 0.9 and a height of about 6 mm at pressures up to 830 MPa at room temperatures or die temperatures up to 150° C. for compaction times of 1 to 2 seconds and ejected from the closed die to form a compacted SMC component. The compacted SMC component is heated to a temperature of 700-800° F. in an air atmosphere for 30-90 minutes to remove the organic lubricant and create a network of inter-connected porosity within the compacted SMC component. The compacted SMC component is optionally impregnated with an aqueous solution of copper nitrate under vacuum at a temperature of up to 190° F. for up to 60 minutes. The amount of copper nitrate infiltration is 1 to 3 weight percent, based on the total weight of the impregnated, compacted SMC component is heated to 1000° F. for 30 to 90 minutes via steam treatment to generate Fe₃O₄ on the surface of the iron powder. The impregnated, compacted SMC component is reheated to 1400° F. for 30 to 60 minutes in a pure (100%) nitrogen atmosphere to cause the copper coating to react with the iron substrate to form a soft magnetic component comprising an oxide. Magnetic testing utilizing an automatic magnetic hysteresis graph shows the magnetic permeability of the copper coated SMC is reduced relative to non-copper coated SMCs. The copper coated SMC shows a higher coercive force. Without wishing to be bound to any particular theory, it is believed that using a pure nitrogen atmosphere in the final thermal treatment causes the degradation of permeability and coercive force due to the formation of non-magnetic oxide during the final thermal treatment.

The following aspects are disclosed in this application:

Aspect 1. A soft magnetic composite as substantially described in the specification and accompanying drawings.

Aspect 2. A method of making a soft magnetic composite as substantially described in the specification and accompanying drawings.

Aspect 3. A CuOFe₂O₃ coating for a soft magnetic composite as substantially described in the specification and accompanying drawings.

Aspect 3. A CuOFe₂O₃ coating for a soft magnetic composite as substantially described in the specification and accompanying drawings.

Aspect 4. A method of making a CuOFe₂O₃ coating for a soft magnetic composite as substantially described in the specification and accompanying drawings.

Aspect 5. A method of coating a soft magnetic composite with a CuOFe₂O₃ coating as substantially described in the specification and accompanying drawings.

Aspect 6. A soft magnetic composite according to any of the foregoing aspects comprising, based on total weight of the composite: 95 to 99 weight percent iron; 0.1 to 3 weight percent electrically insulating material; 0.5 to 2 weight percent CuOFe₂O₃; and a balance of incidental impurities.

Aspect 7. The composite according to any of the foregoing aspects, wherein the electrically insulating material characterized by being capable of withstanding a 1200-1500° F. thermal treatment without significant degradation.

Aspect 3. The composite according to any of the foregoing aspects, wherein the electrically insulating material comprises an electrically insulating oxide.

Aspect 4. The composite according to any of the foregoing aspects, wherein the electrically insulating material comprises at least one of phosphorous acid, phosphorous oxide, and silica oxide.

Aspect 5. A soft magnetic composite according to any of the foregoing aspects comprising, based on total weight of the composite: 95 to 99 weight percent iron powder; 0.1 to 0.75 weight percent hexagonal boron nitride; 1 to 3 weight percent of at least one of copper sulfate penta-hydrate meta and/or magnesium sulfate penta-hydrate and/or copper nitrate and iron nitrate; and a balance of incidental impurities.

Aspect 6. The composite according to any of the foregoing aspects, wherein the hexagonal boron nitride comprises a size range of 5-10 micrometers in diameter.

Aspect 7. The composite according to any of the foregoing aspects, wherein the at least one of copper sulfate penta-hydrate meta and/or magnesium sulfate penta-hydrate and/or copper nitrate and iron nitrate comprises copper sulfate penta-hydrate.

Aspect 8. The composite according to any of the foregoing aspects comprising an oxide layer comprising copper oxides and iron oxides and wherein the oxide layer surrounds the iron power particles.

Aspect 9. The composite according to any of the foregoing aspects characterized by an oxide network surrounding the iron powder particles and being substantially free of inter-particle sintering of the iron powder particles.

Aspect 10. An article comprising the composite according to any of the foregoing aspects, wherein the article comprises at least one of stators and rotors for electric motors.

Aspect 11. A method of making a compacted article according to any of the foregoing aspects may generally comprise: high shear mixing an iron powder and 1-5 weight percent, based on the total weight of the iron powder, of an aqueous solution of one of copper sulfate penta-hydrate, copper nitrate and iron nitrate; compacting the mixture in a mold to make the compacted article; and delubricating the compacted article from the mold.

Aspect 12. The method according to any of the foregoing aspects comprising premixing the iron powder and a compaction lubricant comprises at least one of ethylene bis stearamide, zinc stearate, and any suitable powder metallurgy lubricant.

Aspect 13. The method according to any of the foregoing aspects comprising mixing the iron powder with 0.1-0.75 weight percent, based on the total weight of the iron powder, at least one of hexagonal boron nitride, cubic boron nitride, Fe₂O₃, magnetic ferrites, silicon dioxide powder and any other inorganic compound capable of withstanding 1200-1500° F. thermal treatment without significant degrading.

Aspect 14. The method according to any of the foregoing aspects comprising heating the de-lubricated compacted article via a steam to a temperature of 900-1100° F. to form an iron oxide (Fe₃O₄) layer on the surface of the iron powder.

Aspect 15. The method according to any of the foregoing aspects comprising heating the steamed treated compacted article in a 25-30% oxygen atmosphere and a balance of nitrogen and/or any other inert gas to a temperature of 1300-1500° F. to form the CuOFe2O3 magnetic oxide on the surfaces of the iron powder.

All documents cited herein are incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to this application.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications and substitutions. This application including the appended claims is therefore intended to cover all such changes and modifications that are within the scope of this application.

What is claimed:

1. A soft magnetic composite comprising, based on total weight of the composite:
95 to 99 weight percent iron;
0.1 to 3 weight percent electrically insulating material;
0.5 to 2 weight percent CuOFe₂O₃; and
a balance of incidental impurities.

2. The composite of claim 1, wherein the electrically insulating material characterized by being capable of withstanding a 1200-1500° F. thermal treatment without significant degradation.

3. The composite of claim 1, wherein the electrically insulating material comprises an electrically insulating oxide.

4. The composite of claim 1, wherein the electrically insulating material comprises at least one of phosphorous acid, phosphorous oxide, and silica oxide.

5. A soft magnetic composite comprising, based on total weight of the composite:
95 to 99 weight percent iron powder;
0.1 to 0.75 weight percent hexagonal boron nitride;
1 to 3 weight percent of at least one of copper sulfate penta-hydrate meta and/or magnesium sulfate penta-hydrate and/or copper nitrate and iron nitrate; and
a balance of incidental impurities.

6. The composite of claim 5, wherein the hexagonal boron nitride comprises a size range of 5-10 micrometers in diameter.

7. The composite of claim 5, wherein the at least one of copper sulfate penta-hydrate meta and/or magnesium sulfate penta-hydrate and/or copper nitrate and iron nitrate comprises copper sulfate penta-hydrate.

8. The composite of claim 5 comprising an oxide layer comprising copper oxides and iron oxides and wherein the oxide layer surrounds the iron power particles.

9. The composite of claim 5 characterized by an oxide network surrounding the iron powder particles and being substantially free of inter-particle sintering of the iron powder particles.

10. An article comprising the composite of any of the foregoing claims, wherein the article comprises at least one of stators and rotors for electric motors.

11. A method of making a compacted article may generally comprise:
high shear mixing an iron powder and 1-5 weight percent, based on the total weight of the iron powder, of an aqueous solution of one of copper sulfate penta-hydrate, copper nitrate and iron nitrate;
compacting the mixture in a mold to make the compacted article; and
delubricating the compacted article from the mold.

12. The method of claim 11 comprising premixing the iron powder and a compaction lubricant comprises at least one of ethylene bis stearamide, zinc stearate, and any suitable powder metallurgy lubricant.

13. The method of claim 11 comprising mixing the iron powder with 0.1-0.75 weight percent, based on the total weight of the iron powder, at least one of hexagonal boron nitride, cubic boron nitride, Fe₂O₃, magnetic ferrites, silicon dioxide powder and any other inorganic compound capable of withstanding 1200-1500° F. thermal treatment without significant degrading.

14. The method of claim 11 comprising heating the de-lubricated compacted article via a steam to a temperature of 900-1100° F. to form an iron oxide (Fe₃O₄) layer on the surface of the iron powder.

15. The method of claim 11 comprising heating the steamed treated compacted article in a 25-30% oxygen atmosphere and a balance of nitrogen and/or any other inert gas to a temperature of 1300-1500° F. to form the CuOFe₂O₃ magnetic oxide on the surfaces of the iron powder.
